(19) United States
(12) Patent Application Publication
(10) Pub. No.: US 2021/0216103 A1
(43) Pub. Date: Jul. 15, 2021

(54) FOLDABLE MECHANISM FOR ELECTRONIC DEVICES

(71) Applicant: HEWLETT-PACKARD DEVELOPMENT COMPANY, L.P., Spring, TX (US)

(72) Inventors: Wei-Chung CHEN, Taipei (TW); Kuan-Ting WU, Taipei (TW); Chi-Hao CHANG, Taipei (TW)

(73) Assignee: HEWLETT-PACKARD DEVELOPMENT COMPANY, L.P., Houston, TX (US)

(21) Appl. No.: 16/076,023

(22) PCT Filed: Apr. 20, 2017
(86) PCT No.: PCT/US2017/028511

§ 371 Date: Aug. 7, 2018

(51) Int. Cl. G06F 1/16

(52) U.S. Cl. CPC G06F 1/1652; G06F 1/1681; G06F 1/1616

(57) ABSTRACT

A foldable mechanism is described herein that includes a foldable display device comprising a first plurality of rails and a bracket comprising a second plurality of rails to be interconnected with the first plurality of rails. In some examples, an adhesive attaches the foldable display to a portion of the bracket adjacent to the second plurality of rails and the second plurality of rails enable the foldable display to slide via the first plurality of rails as the bracket transitions between an open state of the system and a closed state of the system.

### BACKGROUND

Many mobile electronic devices have display panels attached to base portions of the mobile electronic devices that include various computing components and input devices. A display panel can be attached to the base portion of the mobile electronic device using various mechanical components. In some examples, the mechanical components can support various viewing angles of the display panel in relation to the base portion of the mobile electronic device.

### DESCRIPTION OF THE DRAWINGS

Certain exemplary embodiments are described in the following detailed description and in reference to the drawings, in which:

FIG. 1 is a block diagram of an example foldable hinge for attaching a display panel to an electronic device;

FIG. 2 is a block diagram of an example foldable hinge with several shafts for attaching a display panel to an electronic device;

FIG. 3 is a block diagram illustrating an example of interconnected sliding links;

FIG. 4 is a block diagram of an example system with a display panel, base portion of the system, and several foldable hinges in an open position;

FIG. 5 is a block diagram of an example system with a display panel, base portion of the system, and several foldable hinges in a closed position;

FIG. 6 is a process flow diagram for manufacturing a foldable hinge;

FIG. 7 is a block diagram of an example computing system that includes a foldable hinge;

FIG. 8 is a block diagram of an example system with a bracket that can be attached to a display panel;

FIG. 9 is a block diagram of an example display panel coupled to a bracket with interconnected rails and adhesive;

FIG. 10 is a block diagram of an example system in a closed position;

FIG. 11 is a block diagram of an example system in a partially opened position;

FIG. 12 is a block diagram of an example system with a display panel in a partially opened position; and

FIG. 13 is a process flow diagram for manufacturing a foldable mechanism for an electronic device.

### DETAILED DESCRIPTION

In embodiments described herein, a foldable hinge can attach a display panel to an input device or a base portion of an electronic device. In some embodiments, the base portion of the electronic device can include processors, graphics cards, audio cards, and the like. In some examples, an input device can be included in the base portion of a device. In some embodiments, the devices can be mobile devices and the foldable hinge can enable users to view the display panel from a range of viewing angles. For example, the folding hinge can enable users to rotate a display panel up to 180 degrees in relation to a base portion of an electronic device.

In some embodiments, the foldable hinge can include a torque engine that enables the foldable hinge to rotate the display panel. The torque engine, as referred to herein, can include any suitable number of curved rails and prongs that reside within various sliding links. The sliding links can be interconnected by inserting the extruding prongs of each sliding link into the curved rails of additional sliding links. The interconnected sliding links enable the foldable hinge to be a stretchable or retractable structure that can rotate an attached display device. In some embodiments, a display panel can be attached to the interconnected sliding links with a bracket and any suitable adhesive. For example, the display panel can include a rail structure, such as rails of a bracket, which can adjust the display panel orientation and prevent a broken display panel when rotating the display panel. In some embodiments, the foldable hinge can enable any suitable viewing range of a display panel in relation to a base portion of an electronic device between zero and one-hundred and eighty degrees.

While some embodiments of the foldable hinge are described below in relation to an X axis, Y axis, and Z axis, these axes are shown and used herein for convenience of description and may not reflect an orientation of the device or its components. The description of each axis in relation to various components of a device is used to provide orientation information for each of the components. In an example, the X axis and Y axis are in the plane of the input device or base of an electronic device, while a Z axis is perpendicular to the input device or base of the electronic device. As observed in the figures, when the electronic device is held flat and viewed on edge in front of the viewer, the X axis is in the direction of left-right, and the Y axis is front-back.

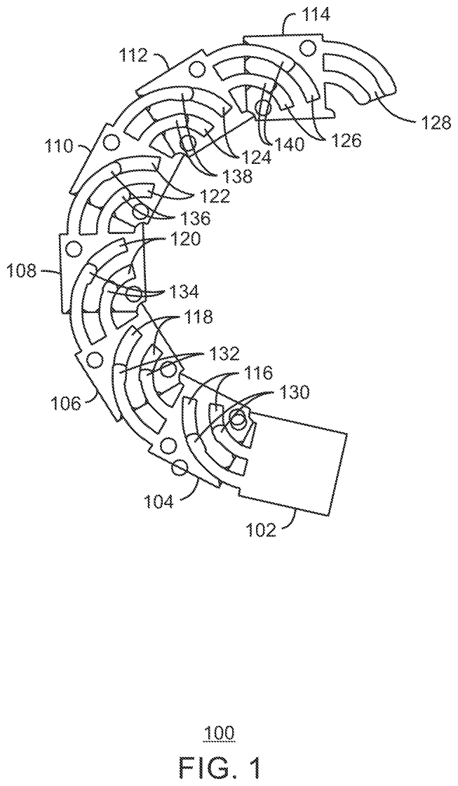

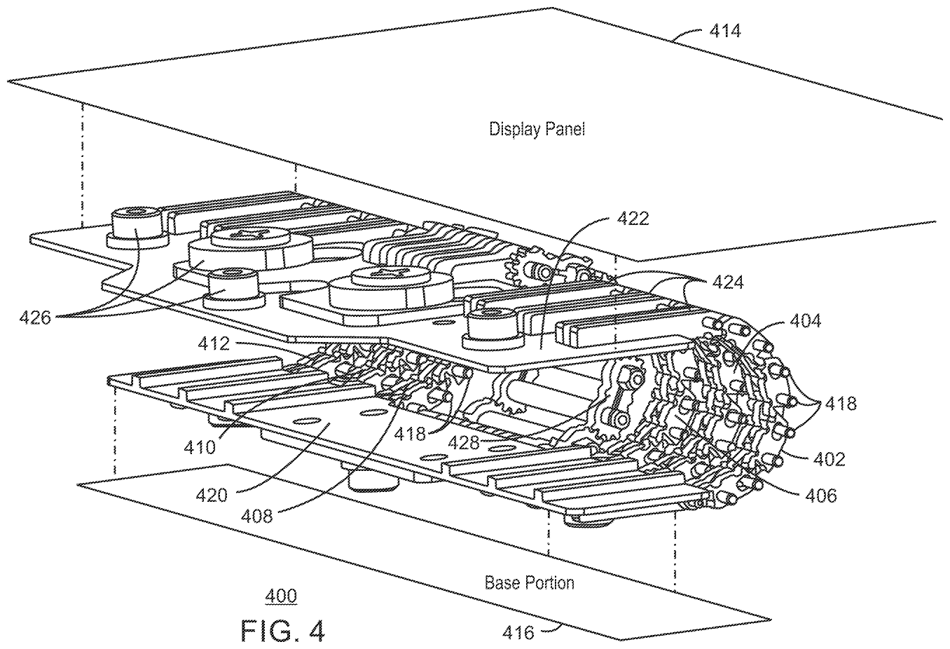

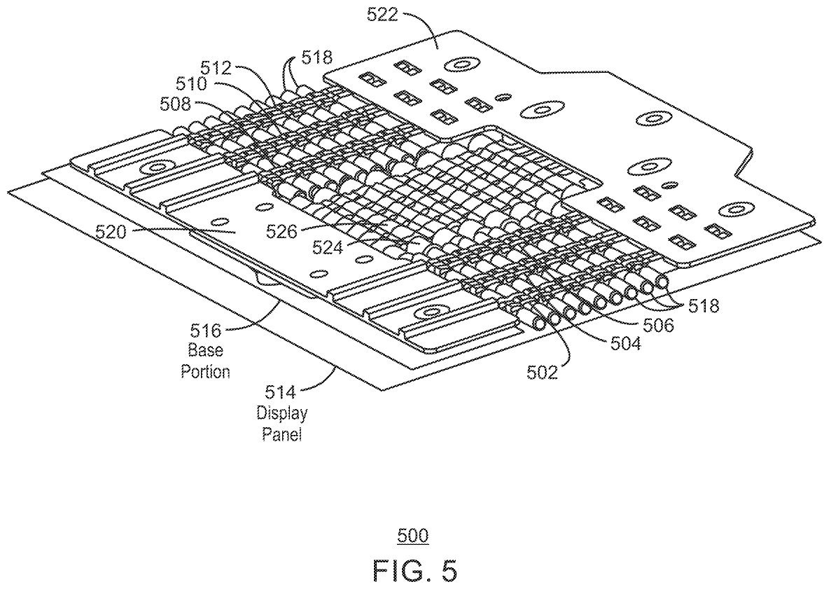

FIG. 1 is a block diagram of an example foldable hinge for attaching a display panel to an electronic device. The foldable hinge 100 can include any suitable number of interconnected sliding links 102, 104, 106, 108, 110, 112, and 114. Sliding link 102 may connect or attach to an input device or a base portion of an electronic device (not depicted). In some examples, sliding link 114 can be attached to a display panel. In some embodiments, sliding link 114 can attach to a bracket affixed to a display panel. In some examples, any suitable number of the interconnected sliding links 102, 104, 106, 108, 110, 112, and 114 can include rails 116, 118, 120, 122, 124, 126, and 128 and extruding prongs 130, 132, 134, 136, 138, and 140. The rails 116-128 can be curved at any suitable angle that corresponds to the angles of the extruding prongs 130-140. The angles at which the rails 116-128 and the extruding prongs 130-140 are curved can provide tension as a display panel is moved away from a base portion of a computing device. Accordingly, the rails 116-128 and extruding prongs 130-140, which form the torque engine described herein, can enable a user of an electronic device to view a display panel at up to a one-hundred and eighty degree angle in relation to a base portion of the electronic device. In some embodiments, the plurality of interconnected sliding links 102-114 enable rotation of a display device in a one-hundred and eighty degree range along an axis proximate an edge of the input device or base of an electronic device. A fully extended or open position of the foldable hinge and a fully retracted or closed position of the foldable hinge are described in greater detail below in relation to FIGS. 4 and 5.

It is to be understood FIG. 1 is not intended to indicate that the foldable hinge 100 is to include all of the components discussed above. Rather, the foldable hinge 100 can include fewer components or additional components.

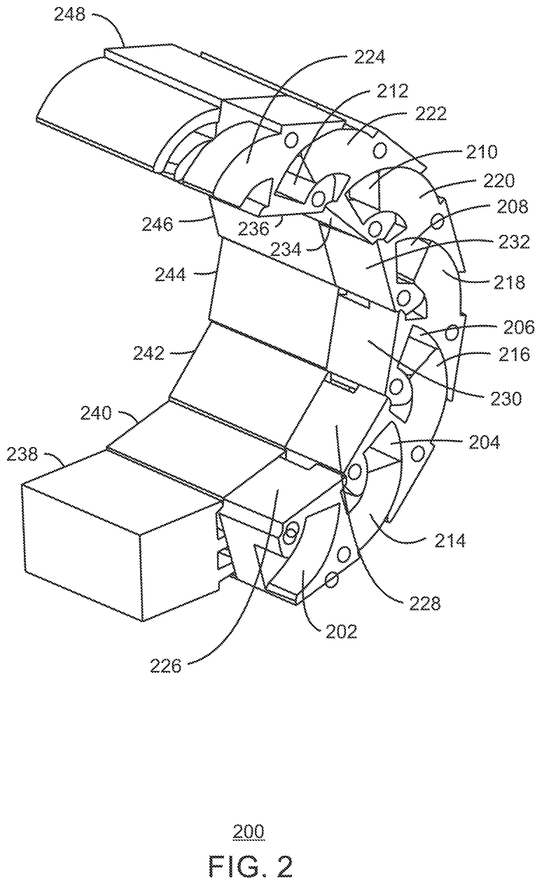

FIG. 2 is a block diagram of an example foldable hinge with several shafts for attaching a display panel to an electronic device. In some examples, the foldable hinge 200 can include any suitable number of curved rails 202, 204, 206, 208, 210, and 212 and extruding prongs 214, 216, 218, 220, 222, and 224 in sliding links 226, 228, 230, 232, 234, and 236. As discussed above, each of the extruding prongs 214-224 can be inserted into the curved rails 202-212. In some examples, foldable hinge 200 can also include any suitable number of shafts 238, 240, 242, 244, 246, and 248 attached to the sliding links 226-236. The shafts 238-248 can enable any suitable number of sets of interconnected sliding links 226-236 to be connected. The shafts are described in greater detail below in relation to FIGS. 4 and 5. In some embodiments, the extruding prong 224 and shaft 248 can be coupled to a display device and the shaft 240 can be coupled or attached to a base portion of an electronic device.

In some embodiments, the foldable hinge 200 can include any suitable number of interconnected sliding links 226-236. In some examples, the number of interconnected sliding links 226-236 included in the foldable hinge 200 can be dependent upon a depth of each interconnected sliding link 226-236, a depth of the curved rails 202-212, and a length of the extruding prongs 214-224. In some examples, the foldable hinge 200 can include any suitable number of interconnected sliding links 226-236 coupled to any other suitable number of links. For example, the foldable hinge 200 may include links without extruding prongs and curved rails, which can be coupled to any suitable number of sliding links with curved rails and extruding prongs.

It is to be understood FIG. 2 is not intended to indicate that the foldable hinge 200 is to include all of the components discussed above. Rather, the foldable hinge 200 can include fewer components or additional components. Furthermore, the foldable hinge 200 can be included in various devices such as electronic devices and lab instrumentation including sample covers, ports, centrifuge covers, and the like.

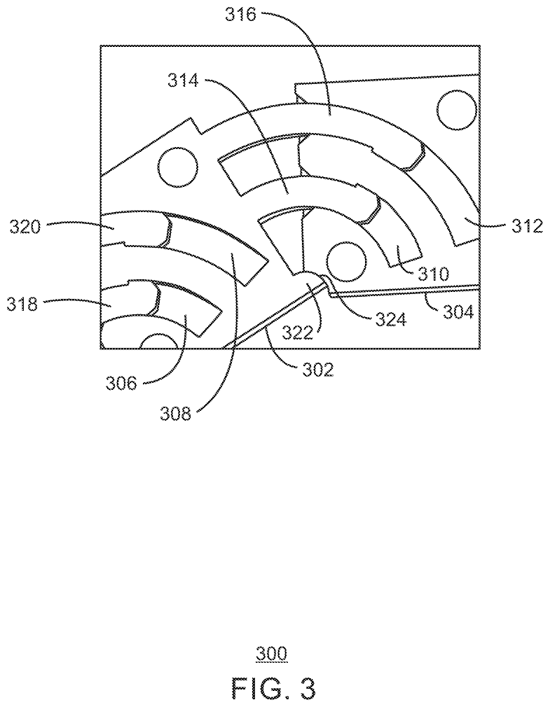

FIG. 3 is a block diagram of example sliding links. In the sliding links 302 and 304 of FIG. 3, each sliding link 302 and 304 can include curved rails 306, 308, 310, and 312. The curved rails 306-312 can be comprised of any suitable material such as stainless steel, plastic, and the like. In some examples, the material of the curved rails can be selected based on an amount of friction generated as pressure forces extruding prongs into the rails. As discussed above, each sliding link 302 and 304 can also include extruding prongs. For example, the sliding link 302 can include extruding prongs 314 and 316. The extruding prongs of sliding link 304 are not included in this figure. Additionally, the curved rails 306 and 308 of sliding link 302 can accept extruding prongs 318 and 320 from an adjacent sliding link that is not illustrated. Each sliding link may also include a ridge and an indention along one side to enable a pivot point between two adjacent sliding links. For example, sliding link 302 includes a ridge 322 and sliding link 304 includes an indention 324. The ridge 322 and the indention 324 enable sliding links 302 and 304 to pivot as extruding prongs 314 and 316 slide into and out of the curved rails 310 and 312.

In FIG. 3, each of the interconnected sliding links comprise two rails to be coupled to two curved extruding prongs. However, it is to be understood that each sliding link could include any suitable number of rails and extruding prongs. Additionally, the rails 306-312 and the extruding prongs 314-320 can interconnect with any suitable angle.

FIG. 4 is a block diagram of an example system with a display panel, base portion of the system, and several foldable hinges in an open position. In the system 400 of FIG. 4, six separate sets of interconnected sliding links 402, 404, 406, 408, 410, and 412 can be used to rotate a display panel 414 in relation to a base portion 416 of the system 400. Each of the sets of interconnected sliding links 402-412 can be attached to one another using a plurality of shafts 418. Accordingly, separate sets of interconnected sliding links are attached via the plurality of shafts, wherein each shaft connects to a separate sliding link. In some examples, the sets of interconnected sliding links 402-412 attach to brackets 420 and 422, which connect the interconnected sliding links 402-412 to the display panel 414 and base portion 416 of the system 400 respectively. The brackets 420 and 422 can include any suitable number of channels 424, knobs 426, and the like, to couple the brackets 420 and 422 to the display panel 414 and the base portion 416 of the system 400.

In some embodiments, a set of interconnected gears 428 can also be included in the system 400 between the sets of interconnected sliding links 406 and 408. The set of interconnected gears 428 can provide additional torque or tension to support the display panel 414 in a variety of viewing angles. In some examples, the set of interconnected gears 428 includes a series of two gears that are each coupled by a gear shaft. The set of interconnected gears 428 can be attached to a flexible material such as cloth, any suitable pliable plastic fiber, and the like. In FIG. 4, the plurality of interconnected sliding links 402-412 are to rotate to enable the display panel 414 to be parallel to the base portion 416 of the system, wherein the display panel 414 and the base portion 416 of the system 400 are in separate planes. For example, the display panel 414 (also referred to as a display device) and a base portion 416 of the system 400 can have the same coordinates along an X axis, while having different coordinates along a Z axis. In some examples, the display panel 414 (also referred to as a display device) and base portion 416 of the system 400 can have any suitable number of shared coordinates in the Y axis. In some embodiments, pressure activates the torque engine of a subset of the plurality of interconnected sliding links resulting in the at least one curved extruding prong being inserted into the at least one rail for each of the subset of the interconnected sliding links 402-412. As the sets of interconnected sliding links 402-412 and the set of interconnected gears 428 rotate in response to pressure, an angle between brackets 420 and 422 can be modified resulting in the display panel 414 rotating proximate the base portion 416 of the system 400.

In FIG. 4, the two brackets 420 and 422 are in a fully open state or configuration in which the base portion 416 of the system 400 is parallel to the display panel 414. Accordingly, the sets of interconnected sliding links 402-412 bend at an angle that overlaps the base portion 416 of the system 400. In other words, the sets of interconnected sliding links 402-412 bend at an angle as extruding prongs are inserted into curved rails in the sets of interconnected sliding links 402-412. The angle of the sets of interconnected sliding links 402-412, which is formed by pressure applied to the sets of interconnected sliding links 402-412, forces a bottom edge of the display panel 414 to reside on top of or over the base portion 416 of the system 400. In one example, the bottom edge of the display panel 414 rotates in a z dimensional plane that also includes an input device embedded in the base portion 416 of the system 400. Accordingly, the sets of interconnected sliding links 402-412 form a curved surface approaching the front of the system 400 rather than forming a curved surface that moves away from the rear of the system 400.

It is to be understood FIG. 4 is not intended to indicate that the system 400 is to include all of the components discussed above. Rather, the system 400 can include fewer components or additional components. For example, the system 400 may include fewer sets of interconnected sliding links 402-412 or additional sets of interconnected sliding links 402-412. Additionally, the system 400 may use an asymmetric design in which a set of interconnected gears is adjacent to one interconnected sliding link on one side and two or three interconnected sliding links on the other side. In some embodiments, the set of interconnected gears 428 may not be included in the system 400 if the sets of interconnected sliding links 402-412 provide enough tension to support a display panel 414 at any suitable angle. Furthermore, in some examples, the sets of interconnected sliding links 402-412 may connect directly to a display panel 414 or a base portion 416 of the system 400 without brackets 420 or 422. Accordingly, the system 400 may not include brackets 420 or 422.

FIG. 5 is a block diagram of an example system with a display panel, base portion of the system, and several foldable hinges in a closed position. In the system 500 of FIG. 5, six separate sets of interconnected sliding links 502, 504, 506, 508, 510, and 512 can be used to rotate a display panel 514 in relation to a base portion 516 of the system 500. Each of the sets of interconnected sliding links 502-512 can be attached to one another using a plurality of shafts 518. In some examples, the sets of interconnected sliding links 502-512 attach to brackets 520 and 522, which connect the interconnected sliding links 502-512 to the display panel 514 and base portion 516 of the system 500 respectively. In some embodiments, a set of interconnected gears 524 and a segment of fabric or any other suitable pliable material 526 can also be included in the system 500 between the sets of interconnected sliding links 506 and 508. The set of interconnected gears 524 can provide additional torque or tension to support the display panel 514 in a variety of viewing angles. In FIG. 5, the plurality of interconnected sliding links 502-512 are to be aligned in a single axis in response to coupling a display device to an input device. The plurality of interconnected sliding links 502-512 can provide tension to prevent the display panel 514 from separating from the base portion 516 of the system 500. In some embodiments, the interconnected sliding links 502-512 are aligned in a single plane or axis along a rear portion of the system 500. For example, the interconnected sliding links 502-512 can reside in a single X-axis plane adjacent to the display panel 514. The interconnected sliding links 502-512 and the display panel 514 can be coupled to the base portion 516 of the system 500 along adjacent planes along the Y-axis.

In some embodiments, each set of interconnected sliding links 502-512 can include any number of sliding links. In some examples, each set of interconnected sliding links 502-512 can include a same number of sliding links. As discussed above, the number of interconnected sliding links 502-512 can be dependent on a depth of each interconnected sliding link 502-512, a depth of the curved rails of the interconnected sliding links 502-512, and a length of the extruding prongs of the interconnected sliding links 502-512.

It is to be understood FIG. 5 is not intended to indicate that the system 500 is to include all of the components discussed above. Rather, the system 500 can include fewer components or additional components. For example, the system 500 may include fewer sets of interconnected sliding links 502-512 or additional sets of interconnected sliding links 502-512. Additionally, the system 500 may use an asymmetric design in which a set of interconnected gears is adjacent to one interconnected sliding link on one side and two or three interconnected sliding links on the other side. In some embodiments, the set of interconnected gears 524 may not be included in the system 500 if the sets of interconnected sliding links 502-512 provide enough tension to support a display panel 514 at any suitable angle.

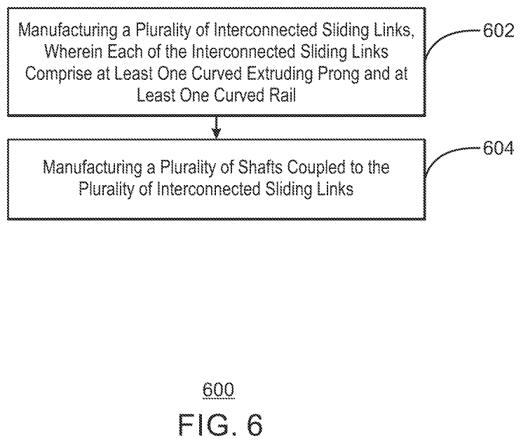

FIG. 6 is a process flow diagram for manufacturing a foldable hinge. The process 600 can be implemented by any suitable manufacturing technique.

At block 602, the process 600 can include manufacturing a plurality of interconnected sliding links, wherein each of the interconnected sliding links comprise at least one curved extruding prong and at least one curved rail. As discussed above, the at least one curved rail of a first interconnected sliding link is coupled to the at least one curved extruding prong of a second interconnected sliding link forming a torque engine. In some embodiments, the interconnected sliding links are rotatable based on a pressure applied to the interconnected sliding links. The extruding prongs and curved rails of the plurality of interconnected sliding links can be curved at any suitable angle to enable the plurality of interconnected sliding links to rotate at any suitable angle. In some examples, the angle of rotation of the plurality of interconnected sliding links can be dependent on the curvature of the extruding prongs and the curved rails, the depth of the interconnected sliding links, and the number of interconnected sliding links. In some examples, the process 600 can detect the number of interconnected sliding links to manufacture based on a number of interconnected sliding links that results in a one-hundred and eighty degree rotation of a display panel in relation to a base portion of an electronic device.

At block 604, the process 600 can also include manufacturing a plurality of shafts coupled to the plurality of interconnected sliding links, wherein each shaft is coupled to a separate interconnected sliding link. As illustrated above in relation to FIGS. 4 and 5, each shaft can connect any suitable number of sets of interconnected sliding links. For example, each shaft can connect sliding links from two, three, or any other suitable number of sets of interconnected sliding links that reside parallel to one another. In some embodiments, a device can include multiple sets of shafts that connect separate groups of interconnected sliding links. For example, a first set of shafts may connect two or three sets of interconnected sliding links and a second set of shafts may connect two or three different sets of interconnected sliding links. A device may include multiple sets of shafts if the device includes features between sets of interconnected sliding links. For example, a set of gears may be included between two sets of interconnected sliding links, which can prevent a set of shafts from connecting interconnected sliding links on either side of the set of gears.

The description of process 600 in FIG. 6 is not intended to indicate that blocks 602 and 604 are to be executed in any particular order. In some examples, block 604 can be executed prior to block 602. Furthermore, the process 600 may include any number of additional blocks. For example, the process 600 can also include manufacturing two brackets, wherein each bracket attaches to opposite ends of the interconnected sliding links. The brackets can be used to mount a display panel and a base portion of an electronic device to the interconnected sliding links. Additionally, the process 600 can also include manufacturing a set of gears to reside between multiple sets of interconnected sliding links, as illustrated above in relation to FIGS. 4 and 5. In some examples, the process 600 can also include manufacturing any suitable pliable fabric or plastic to cover gear shafts included in the set of gears.

In some embodiments, the set of interconnected sliding links can be combined with non-interconnected sliding links. For example, a foldable hinge may include interconnected sliding links in the center surrounded by non-interconnected sliding links. The non-interconnected sliding links may bend and rotate using any suitable technique without extruding prongs and curved rails.

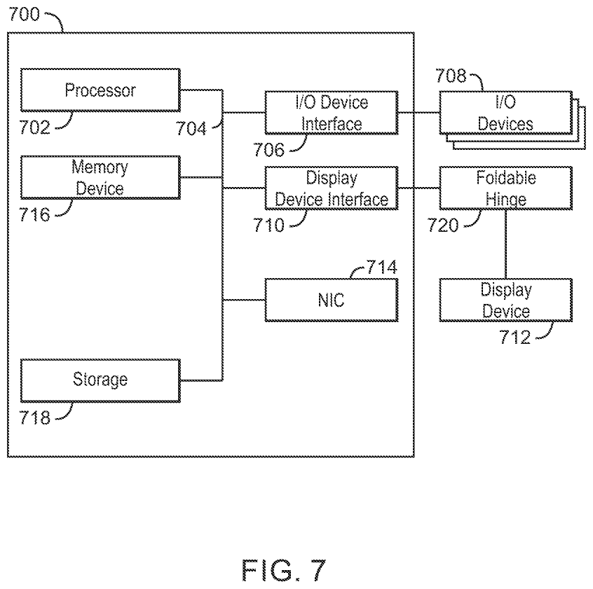

FIG. 7 is a block diagram of an example computing system that includes a foldable hinge. The computing system 700 may include, for example, a server computer, a mobile phone, laptop computer, desktop computer, or tablet computer, among others. The computing system 700 may include a processor 702 that is adapted to execute stored instructions. The processor 702 can be a single core processor, a multi-core processor, a computing cluster, or any number of other appropriate configurations.

The processor 702 may be connected through a system bus 704 (e.g., AMBA®, PCI®, PCI Express®, Hyper Transport®, Serial ATA, among others) to an input/output (I/O) device interface 706 adapted to connect the computing system 700 to one or more I/O devices 708. The I/O devices 708 may include, for example, a keyboard and a pointing device, wherein the pointing device may include a touchpad or a touchscreen, among others. The I/O devices 708 may be built-in components of the computing system 700, or may be devices that are externally connected to the computing system 700.

The processor 702 may also be linked through the system bus 704 to a display device interface 710 adapted to connect the computing system 700 to display device 712. The display device 712 may include a display screen that is a built-in component of the computing system 700. The display device 712 may also include computer monitors, televisions, or projectors, among others, that are externally connected to the computing system 700. Additionally, the processor 702 may also be linked through the system bus 704 to a network interface card (also referred to herein as NIC) 714. The NIC 714 may be adapted to connect the computing system 700 through the system bus 704 to a network (not depicted). The network may be a wide area network (WAN), local area network (LAN), or the Internet, among others.

The processor 702 may also be linked through the system bus 704 to a memory device 716. In some examples, the memory device 716 can include random access memory (e.g., SRAM, DRAM, eDRAM, EDO RAM, DDR RAM, RRAM®, PRAM, among others), read only memory (e.g., Mask ROM, EPROM, EEPROM, among others), non-volatile memory (PCM, STT_MRAM, ReRAM, Memristor), or any other suitable memory systems. In some embodiments, the processor 702 may also be linked through the system bus 704 to a storage device 718. The storage device 718 can include any suitable number of software modules or applications.

In some embodiments, a foldable hinge 720 attaches the display device 712 to the computing system 700. For example, as discussed above, the foldable hinge 720 can include any suitable number of interconnected sliding links that couple to one another with extruding prongs and curved rails. In some embodiments, the display device 712 can be attached to the computing system 700 with any number of foldable hinges 720. In some examples, the computing system 700 is a base portion of a system that is attached to a display device 712 via the foldable hinge 720.

When the display device 712 is separated or pulled away from the computing system 700 in an open position, the foldable hinge 720 can provide torque or tension to support the display device 712 in a variety of viewing angles. A plurality of interconnected sliding links in the foldable hinge 720 can rotate to enable the display device 712 to be parallel to the computing system 700, wherein the computing system 700 and display device 712 are in separate planes. For example, the display device 712 and the computing system 700 can have the same coordinates along an X axis, while having different coordinates along a Z axis. In some examples, the display device 712 and computing system 700 can have any suitable number of shared coordinates in the Y axis. Accordingly, a portion of the display device 712 may overlap a portion of the computing system 700 in an open state. In some embodiments, pressure activates the torque engine of a subset of the plurality of interconnected sliding links in the foldable hinge 720 resulting in at least one curved extruding prong being inserted into at least one rail for each of the subset of the interconnected sliding links. As the sets of interconnected sliding links of the foldable hinge 720 rotate in response to pressure, an angle between the display device 712 and the computing system 700 can be modified.

When the display device 712 is coupled to the computing system 700 in a closed position, the foldable hinge 720 can provide torque or tension to maintain a closed position. For example, the foldable hinge 720 can include sets of interconnected sliding links that can be attached to one another using a plurality of shafts. In some examples, the sets of interconnected sliding links of the foldable hinge 720 are connected to the display device 712 and the computing system 700. In some embodiments, the foldable hinge 720 can also include a set of interconnected gears that provide additional torque or tension to keep the display device 712 coupled to the computing system 700. In a closed position, the foldable hinge 720 is aligned in a single axis in response to coupling the display device 712 to the computing system 700.

In some embodiments, the foldable hinge 720 can include any number of sets of interconnected sliding links that can include any number of sliding links. In some examples, each set of interconnected sliding links of the foldable hinge 720 can include a same number of sliding links. As discussed above, the number of interconnected sliding links of the foldable hinge 720 can be dependent on a depth of each interconnected sliding link, a depth of the curved rails of the interconnected sliding links, and a length of the extruding prongs of the interconnected sliding links.

It is to be understood that the block diagram of FIG. 7 is not intended to indicate that the computing system 700 is to include all of the components shown in FIG. 7. Rather, the computing system 700 can include fewer or additional components not illustrated in FIG. 7 (e.g., additional memory devices, video cards, additional network interfaces, sets of gears in the foldable hinge, additional foldable hinges, etc.).

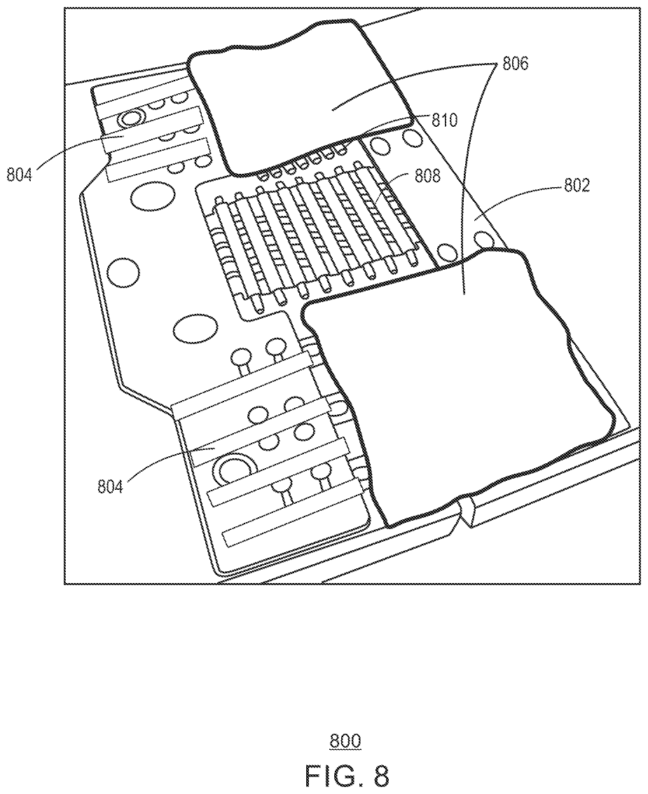

In some examples, the foldable hinge described above can also be included in a foldable mechanism that enables an electronic device to fold as described below in relation to FIGS. 8-13. The foldable mechanism, as described herein, can include a bracket, a foldable display, and a foldable hinge, among other features illustrated in FIGS. 8-13.

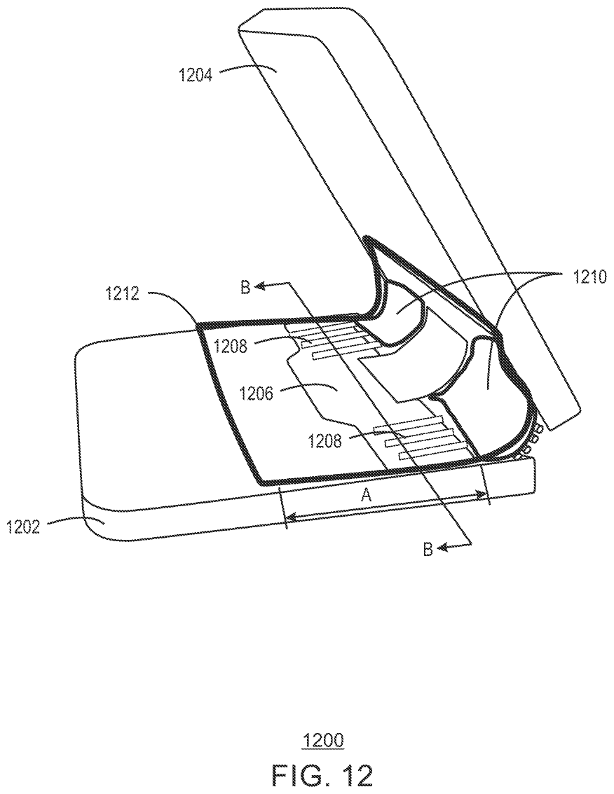

FIG. 8 is a block diagram of an example system with a bracket that can be attached to a display panel. In some examples, system 800 can include a bracket 802 that can include any suitable number of rails 804 and an adhesive 806. In some embodiments, a display panel (not depicted) can be attached to the bracket 802 via the adhesive 806 and the rails 804. For example, the adhesive 806 can attach a first portion of a display panel to the bracket 802 and the rails 804 can attach a second portion of the display panel to the bracket 802. In some examples, the bracket 802 can include adhesive 806 and rails 804 on various portions of the bracket 802. For example, the bracket 802 can include adhesive 806 and rails 804 located on two segments or sections of the bracket 802, which can enable a set of interconnected gears 808 to reside between the areas of adhesive 806 and rails 804. The set of interconnected gears 808 can be attached to a flexible material such as cloth, any suitable pliable plastic fiber, and the like. In some embodiments, any suitable number of interconnected sliding links can reside in the bracket 802 beneath areas of the bracket 802 that include an adhesive 806. In some examples, separate sets of interconnected sliding links are attached via a plurality of shafts 810, wherein each shaft connects to a separate sliding link. In some embodiments, as the interconnected sliding links rotate in response to pressure, an angle formed by the bracket 802 can be modified resulting in a display panel sliding along the rails 804 as described in greater detail below in relation to FIG. 12.

It is to be understood that the bracket 802 may include fewer components or any number of additional components. For example, the bracket 802 may include additional rails, or additional areas of adhesive, among others.

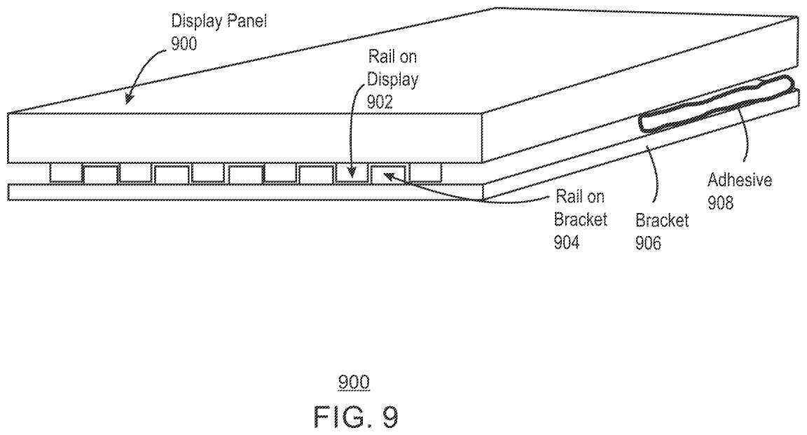

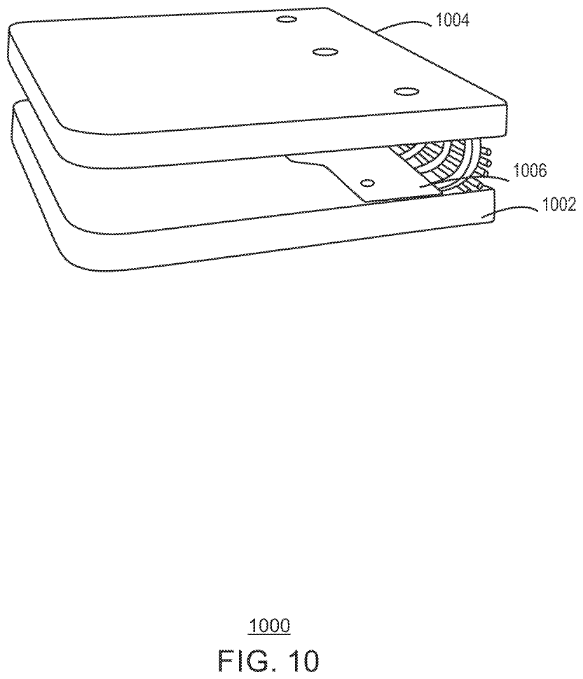

FIG. 9 is a block diagram of an example display panel coupled to a bracket with interconnected rails and adhesive. In some examples, the display panel 900 can be any suitable foldable display (also referred to herein as a flexible display) that can include a flexible organic light emitting diode (OLED) display panel, among others. The display panel 900 can include any suitable number of rails 902 attached to a first segment or portion of the display panel 900. In some embodiments, the rails 902 of the display panel 900 can be interconnected with a second set of rails 904 of a bracket 906. Additionally, the display panel 900 can be attached to the bracket 906 with adhesive 908 applied to a second segment or portion of the display panel 900. In some examples, the adhesive 908 attaches the display panel 900 to the bracket 906 at an area of the display panel 900 that is adjacent to the rails 902 of the display panel 900. In some embodiments, as the bracket 906 transitions from an open position to a closed position, the display panel 900 can slide along the interconnected rails 902 and 904 to prevent the display panel 900 from being damaged. The bracket 906 transitioning from an open position to a closed position is described in greater detail below in relation to FIGS. 10-12.

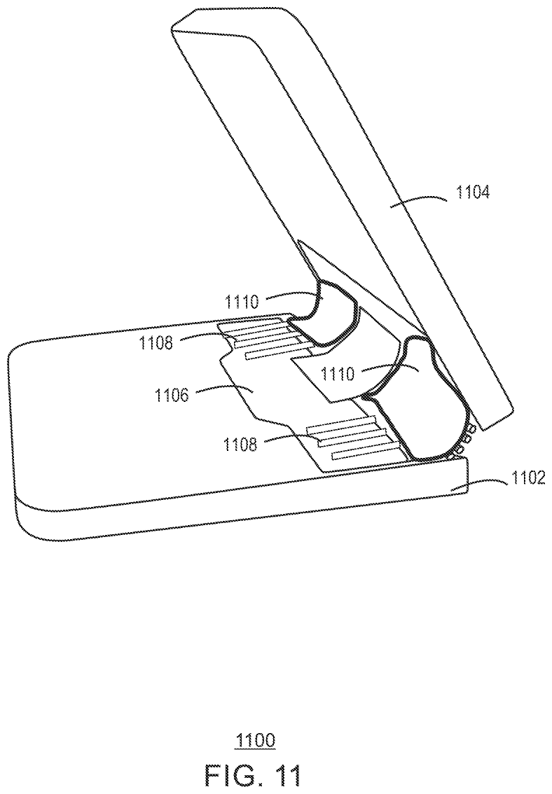

FIG. 10 is a block diagram of an example system in a closed position. In some examples, the system 1000 can include two substrates 1002 and 1004 attached to a bracket 10006. The substrates 1002 and 1004 can include any suitable printed circuit board, electrical components, processors, memory, storage devices, enclosure materials, and the like. In some examples, the substrates 1002 and 1004 can include any suitable plastic, rubber, or metal enclosures to provide protection for electronic components mounted to the substrates 1002 and 1004. In some examples, the two substrates 1002 and 1004 or sections of substrates can each attach to a separate edge of the bracket 1006. For example, the two substrates 1002 and 1004 can be mounted to the bracket 1006 such that the two substrates 1002 and 1004 rotate along edges of the substrates 1002 and 1004 as the bracket 1006 transitions between a closed position and an open position. In some embodiments, the bracket 1006 can be attached to a display panel (not depicted) that resides between the substrates 1002 and 1004. In some examples, the bracket 1006 can be attached to a display panel with any suitable number of rails and areas of adhesive as described in greater detail below in relation to FIGS. 11 and 12. The example system 1000 illustrated in FIG. 10 depicts a system 1000 in a closed position or state, in which the display panel resides between substrates 1002 and 1004 and is not viewable to a user.

FIG. 11 is a block diagram of an example system in a partially opened position. The system 1100 can include two substrates 1102 and 1104 attached to a bracket 1106. As discussed above, the substrates 1102 and 1104 can include any suitable printed circuit board, electrical components, processors, memory, storage devices, enclosure materials, and the like. In some embodiments, the bracket 1106 can include any suitable number of rails 1108 and adhesive 1110. The rails 1108 and adhesive 1110 can enable a flexible display panel (not depicted) to be attached to the bracket 1106. The flexible display panel can reside on top of the rails 1108 and the adhesive 1110 and is described below in relation to FIG. 12.

In some examples, a set of interconnected sliding links can be included in the bracket 1106 and reside in the bracket 1106 below the areas of adhesive 1110. The set of interconnected sliding links can be used as a torque engine and foldable hinge to enable the system 1100 to remain at a static viewing angle. For example, the sets of interconnected sliding links can maintain a constant angle between substrates 1102 and 1104 to enable a flexible display panel residing on the rails 1108 and adhesive 1110 to be viewable. As discussed above, each of the interconnected sliding links can include a curved rail and an extruding prong. In some embodiments, sets of interconnected sliding links can be attached via a plurality of shafts.

It is to be understood that the system 1100 of FIG. 11 may include fewer features or additional features. For example, the system 1100 may include one, two, three, or any other suitable number of sets of rails. Additionally, any number of rails 1108 can be included in each set of rails. Similarly, any suitable number of areas of adhesive 1110 can attach a flexible display panel to the bracket 1106.

FIG. 12 is a block diagram of an example system in a partially opened position. The system 1200 can include two substrates 1202 and 1204 attached to a bracket 1206. In some embodiments, the bracket 1206 can include any suitable number of rails 1208 and adhesive 1210. The rails 1208 and adhesive 1210 can enable a flexible display panel 1212 to be attached to the bracket 1206. In some embodiments, the flexible display panel 1212 resides on top of the rails 1208 and the adhesive 1210. The flexible display panel can include any suitable foldable or flexible display device such as a flexible OLED, among others. In some examples, a set of interconnected sliding links can be used as a torque engine or foldable hinge to enable the system 1200 to remain at a static viewing angle. In some embodiments, the interconnected sliding links can be included in the bracket 1206 below the areas of adhesive 1210.

In some examples, the flexible display panel 1212 can slide in the B direction depicted in FIG. 12 in response to the system 1200 transitioning from an open state to a closed state. For example, as substrates 1202 and 1204 are coupled together in a closed state, the flexible display panel 1212 can slide or retract in the B direction. In some embodiments, the flexible display panel 1212 can slide in the B direction using rails 1208, which facilitate sliding the flexible display panel 1212 such that varying portions of the flexible display panel 1212 are located on segment A of substrate 1202. As described above in relation to FIG. 9, the flexible display panel 1212 can include rails that are interconnected with rails 1208 to enable the flexible display panel to slide in the B direction.

In some examples, the plurality of rails 1208 reside on two sections of one side of the bracket 1206. In some examples, the plurality of rails 1208 are located proximate sets of interconnected sliding links. For example, the sets of interconnected sliding links can reside in the bracket 1206 and provide a torque engine to keep the display panel 1212 at an appropriate viewing angle. In some embodiments, an open state of system 1200 can include the flexible or foldable display device 1212 sliding to an end of the plurality of rails 1208 proximate bracket 1206. The foldable display panel 1212 can slide in the opposite direction of the B direction in response to the system 1200 opening. In some embodiments, a closed state comprises the foldable display device 1212 sliding to an end of the plurality of rails 1208 proximate an outer edge of the system 1200 that does not include bracket 1206. It is to be understood that the system 1200 of FIG. 12 may include fewer features or additional features.

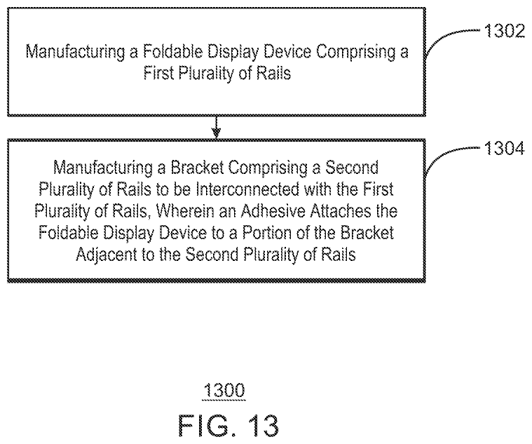

FIG. 13 is a process flow diagram for manufacturing a foldable mechanism for an electronic device. The process 1300 can be implemented with any suitable manufacturing process or technique.

At block 1302, the process 1300 can include manufacturing a foldable display device comprising a first plurality of rails. In some embodiments, the foldable display can include any suitable flexible or foldable display panel that can include a flexible organic light emitting diode (OLED), among others. In some examples, the first plurality of rails can be attached to the display panel using adhesive or a mechanical component, among others. The first plurality of rails can also be comprised of plastic, rubber, metal, or any other suitable material. As depicted in FIGS. 8-12 above, the first plurality of rails can reside on a portion of the flexible display device. In some examples, the first plurality of rails can be arranged at any suitable angle in relation to the foldable display panel.

At block 1304, the process 1300 can include manufacturing a bracket comprising a second plurality of rails to be interconnected with the first plurality of rails. In some examples, an adhesive attaches the foldable display to a portion of the bracket adjacent to the second plurality of rails. The adhesive can include any suitable stretchable adhesive, among others. In some examples, the second plurality of rails enable the foldable display to slide via the first plurality of rails as the bracket transitions between an open state of the system and a closed state of the system. In some embodiments, the bracket can be operated in a one hundred and eighty degree range of motion and the foldable display device can slide along the first plurality of rails and second plurality of rails.

In some examples, the bracket can be attached to two substrates to form a computing device such as a tablet device, a mobile device, a wearable device, a laptop device, among others. In some examples, the two substrates can include any suitable number of electronic components such as processors, memory components, storage devices, input/output interfaces, input/output devices, network interface cards, and the like.

The description of process 1300 in FIG. 13 is not intended to indicate that blocks 1302 and 1304 are to be executed in any particular order. In some examples, block 1304 can be executed prior to block 1302. Furthermore, the process 1300 may include any number of additional blocks. For example, the process 1300 can also include manufacturing a bracket that includes a foldable hinge. The foldable hinge can include a plurality of interconnected sliding links, wherein each of the interconnected sliding links comprise at least one curved extruding prong and at least one curved rail. In some examples, the at least one curved rail of a first interconnected sliding link can be coupled to the at least one curved extruding prong of a second interconnected sliding link forming a torque engine, wherein the interconnected sliding links are rotatable based on a pressure applied to the interconnected sliding links. In some examples, the bracket can also include a plurality of shafts coupled to the plurality of interconnected sliding links, wherein each shaft is coupled to a separate interconnected sliding link.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A system comprising:
a foldable display device comprising a first plurality of rails; and
a bracket comprising a second plurality of rails to be interconnected with the first plurality of rails, wherein an adhesive attaches the foldable display device to a portion of the bracket adjacent to the second plurality of rails, and wherein the second plurality of rails enable the foldable display device to slide via the first plurality of rails as the bracket transitions between an open state of the system and a closed state of the system.

2. The system of claim 1, wherein the foldable display device comprises a flexible organic light emitting diode (OLED).

3. The system of claim 1, wherein the system comprises two sections of substrate, wherein each section of substrate attaches to a separate edge of the bracket.

4. The system of claim 1, wherein the second plurality of rails reside on two sections of one side of the bracket.

5. The system of claim 4, wherein the second plurality of rails are located proximate an interconnected sliding link.

6. The system of claim 1, wherein the open state comprises the foldable display device sliding to an end of the second plurality of rails proximate the bracket.

7. The system of claim 6, wherein the closed state comprises the foldable display device sliding to an end of the second plurality of rails proximate an outer edge of the system that does not include the bracket.

8. A method for manufacturing a device comprising:
manufacturing a foldable display device comprising a first plurality of rails; and
manufacturing a bracket comprising a second plurality of rails to be interconnected with the first plurality of rails, wherein an adhesive attaches the foldable display device to a portion of the bracket adjacent to the second plurality of rails, and wherein the second plurality of rails enable the foldable display device to slide via the first plurality of rails as the bracket transitions between an open state of the system and a closed state of the system.

9. The method of claim 8, wherein the foldable display device comprises a flexible organic light emitting diode (OLED).

10. The method of claim 8, wherein the system comprises two sections of substrate, wherein each section of substrate attaches to a separate edge of the bracket.

11. The method of claim 8, wherein the second plurality of rails reside on two sections of one side of the bracket.

12. The method of claim 11, wherein the second plurality of rails are located proximate an interconnected sliding link.

13. The method of claim 8, wherein the open state comprises the foldable display device sliding to an end of the second plurality of rails proximate the bracket.

14. The method of claim 8, wherein the closed state comprises the foldable display device sliding to an end of the second plurality of rails proximate an outer edge of the system that does not include the bracket.

15. A system comprising:
a foldable display device comprising a first plurality of rails;
a bracket comprising a second plurality of rails to be interconnected with the first plurality of rails, wherein an adhesive attaches the foldable display device to a portion of the bracket adjacent to the second plurality of rails, and wherein the second plurality of rails enable the foldable display device to slide via the first plurality of rails as the bracket transitions between an open state of the system and a closed state of the system, and wherein the bracket comprises a foldable hinge comprising:
a plurality of interconnected sliding links, wherein each of the interconnected sliding links comprise at least one curved extruding prong and at least one curved rail, wherein the at least one curved rail of a first interconnected sliding link is coupled to the at least one curved extruding prong of a second interconnected sliding link forming a torque engine, wherein the interconnected sliding links are rotatable based on a pressure applied to the interconnected sliding links; and
a plurality of shafts coupled to the plurality of interconnected sliding links, wherein each shaft is coupled to a separate interconnected sliding link.
